(19) United States
(12) Patent Application Publication
(10) Pub. No.: US 2020/0066239 A1
(43) Pub. Date: Feb. 27, 2020

(54) Sang Lee's Music Notation System, SALEMN, Maps Out Space-Time Topology of Sound, Enriches Palettes of Colors via Hand-Brush Techniques

(71) Applicant: Sang C. Lee, Wayne, NJ (US)

(72) Inventor: Sang C. Lee, Wayne, NJ (US)

(21) Appl. No.: 16/109,808

(22) Filed: Aug. 23, 2018

(51) Int. Cl. G10G 1/02

(52) U.S. Cl. CPC G10G 1/02

(57) ABSTRACT

For 300 years, elegant Music Notation System, has been developed. Musicians, and lay people, struggled to learn and apply it. The System is overly complex, and Musicians and laymen, struggled to master the Notation System. This Invention, changes that landscape, shedding all complexity, limiting the role of Rhythmic notes, to Rhythms, Time, Duration of sound, without Notes darting, dancing around the staff, up and down, across, for pitches. Emphasis is placed on assigning each musical note, Pitch ID, of Octave number and Note ID. The traditional format of placing Staff, of 5 parallel lines, G, C, F Clefs, # or b (Flat), symbols for Scale, Key, next to Clefs, are all Eliminated. Reading notes on the Stem, bottom-up, LH to RH, for pitch or piano Key information, in concentrated Space-Time Topology of sound, made Reading, Playing music, efficient. Hand-Brush technique and Notation system are invented to enrich sound pallet.

This submission, Music Notation System is aimed at expanded musical sonority of Handbrush techniques, using hands, fists, palms, fingers.

Sang Lee's Music Notation System, SALEMN, Maps Out Space-Time Topology of Sound, Enriching Palette of Colors via Hand-Brush Techniques. SOLMN, the Acronym, is pronounced as in Solemn. Virtually all frivolity of Traditional Music Notation System of 300 years, is not used. The Invention uses Digital Pitch ID, for keys, on Piano Keyboard, Black and White. Digital Pitch ID with two components: Octave number, and Note ID, within Octave. Above the Middle C, Octave number is assigned a positive Integer number, 1, 2, 3 . . . . In ascending order of Octaves. Below the Middle C, is assigned −1, −2, −3 . . . , in descending order of Octaves.

Second component is the Note ID, assigned to each key, black, and white. Within the Octave, 12 notes, keys, are equally spaced at a half interval, on Piano Keyboard, as Bach invented in his “Well-Tempered Clavier”. The note, key, 1 through 12, In an Octave, have 5 Black keys, and 7 White keys. Conventional names of 12 keys, are C, C #, D, D #, E, F, F #, G, G #, A, A #, B. There are 5 Black keys, C #, D #, F #, G #, A #, and 7 White keys, C, D, E, F, G, A, B. In Sang Lee's Notation system, Note ID is as follows: 1=C, 2=C #, 3=D, 4=D #, 5=E, 6=F, 7=F #, 8=G, 9=G #, 10=A, 11=A #, 12=B.

For example, Note, E, or key, in the Second Octave above the Middle C, would have Pitch ID, 2.5. Period or dot, separates Octave number and, Note ID. “Period” or “Dot”, is used in Scores and Descriptive statements. Current, Traditional Music Notation system, has over 300 years of tradition. It is rather complex, and is the only system for writing music scores, Classic or Popular. This invention, retains rhythmic notes or notation, but only used for rhythmic notations, time duration of sound, but not pitches. This invention, does not deal with how to compose music. It deals with Notation System in conjunction with Hand-brush techniques. It can coexist with the current system. Traditional music notation system has, Clef, Staff of 5 parallel lines, and Rest or Pause symbols, as currently exists in traditional notation. SOLEMN, for Rest, simply does not assign Pitch ID. “#”, “sharp”, symbol is to raise an interval by a half, or “b” (flat) lowers interval by a half. “Natural” cancels Preceding effect of # or b, is used to raise the note by a half interval, or to reduce.

The percussive origin of Piano has been neglected. Piano is not a continuous, melodic instrument, such as string instrument, Violin. This invention expands tone colors, by using Hand-Brush, consisting of fists, fingers, palms. Notation systems for “Hand-Brush” is added to enhance traditional “note system that uses primarily finger tips for tone colors. In orchestration, multi notes are played by multi instruments. Finger dexterity is so desirable, many pianists exercised fingers, especially the Ring finger, in unusual manner, such as suspending fingers with string from a high point. Such finger exercises, injured fingers, disabling them. Repetitive, finger motions, made pianists susceptible to injury, suffering from Carpal Tunnel syndrome. They include, Robert Schumann, Poet of Piano music, Leon Fleisher, and Gary Grafmann. Pianists with disabled fingers, can no longer play piano, let alone becoming Concert Pianists. Ravel's Piano Concerto for Left Hand, is about the only serious piano concerto, for the left handed. It is imperative that Notation system must be expanded to add more sounds and colors. Composers struggled to expand colors of piano sound as well as orchestration. Bela Bartok, once asked Henry Cowell for permission to use Tone clusters for piano music. “One Finger per Note” principle has been honored. This Invention, expands colors, via Hand-Brush technique.

Sang Lee's Notation system, is easy to recognize key visually and remember.

The sound and pitch of each note, is associated with Piano keyboard keys. People in due time, would acquire Absolute pitches, moving away from Relative pitches. Unlike Traditional Notation System of Staff, 5 Parallel lines, G Clef, and F Clef, where eyes darting up and down, chasing the dancing notes on Staff, there are no problems of visual association, in SOLEMN, with keys, fingering, and sounds. There is no more guessing, of half tone up, or down. Each Key, having a Note ID, People develop accurate sense of Absolute Pitch. Truly, Astonishing. Complexity, Frivolity of elements, that have been sacrosanct to traditional notation system, melt away, shedding clothes. It is a boom to orchestral conductors, never getting lost conducting. It will become reality, that, in due time, in digital system, a red vertical digital Help-line activated, parallel to the Bar line, and note stems placed on it, will show, every note and sound, that will sound synchronously, simultaneously, in Sang Lee's Notation System.

Sang Lee's Notation system maps out Space-Time Topology of all Sound at any given moment and space. Conductors, performers, will clearly visualize keys and hear all sound, at every moment, time and space, on the score.

Bach, in his invention of Well-tempered Clavier system, divided an octave into 12 equal half tones. A diatonic music scale has 12 equal half tones within an octave. In reality, in a diatonic scale, the distance between 7th, leading tone, and the root, Tonic, is shorter in nature. Since a scale can be rooted on any note, without Bach's system, it was impossible to change keys instantaneously, such as G major to E major. Obviously, piano or organ cannot be tuned in real time, for any modulation of key. That makes impossible to play or modulate a song or instrumental music on different keys. With Bach's system, artificially dividing an octave into 12 equal parts, ignoring micro-tonal nature of leading tone to tonic or root tone, that problem was resolved. This is why piano is tuned periodically by professional tuners. This introduces 5 Black keys between CD, DE, FG, GA, AB, since, in Diatonic Scale, E F, and BC, are half intervals, in a major scale. There are five black keys and seven white keys, altogether 12 keys, in an octave. Five parallel lines, Staff, are introduced for score. Notes are placed on the lines, and on space, between lines. To accommodate, different ranges of voices and instruments, Clef was invented. G Clef or Treble Clef, was introduced for higher register tones, Violin or Soprano for example. Writing G clef symbol starts from the second parallel line, G, above the middle C.

Then, there is the middle C line below E note. F Clef starts writing from the F line below the Middle C, to accommodate lower tonal ranges. C clef denotes the Middle C note, mainly used for Viola. Clef identifies Staff line.

Usually, music is written mainly on a particular scale or key. For example, Major scale has a half interval between E and F, and, B and C. To indicate particular scale, or key, intervals must be changed to create this scale structure, by either elevating by a half interval with “#”, sharp, or bringing a half note down, by adding “b”, flat, to maintain the scale structure. These symbols, # or b, are noted at the beginning of the Staff, next to Clef Symbols. When a temporary modulation takes place, # or b would be placed immediately on an affected note. When it is no longer needed, “Natural” symbol is placed to cancel the change.

These components of traditional system, make musical notation system complex. Players must remember, which note is elevated or lowered by half interval on the Staff. Particularly, above the preprinted five lines or below, additional lines must be added when needed, and performers must remember which additional lines have # or b, since they are only noted right after the G or F Clef. it is difficult to sight-read.

This invention, eliminates complex notation convention, making them simple to read. Bach's vision, is amazing. Sang Lee's Notation System accommodates Bach's system, including atonal music where no scale or key exists. Simplicity of Salemn notation is truly astonishing.

Readers should consult “Drawings” and four citations below,

### REFERENCES

1. Musical notation—Wikipedia
https://en.wikipedia.org/wiki/Musical_notation
2. Clef—Wikipedia
https://en.wikipedia.org/wiki/Clef
3. Lesson 1: Staff, names of notes, treble clef
https://www.khanacademy.org/humanities/music/music-basics2/reading-music2/v/lesson-1-staff-names-of-notes-treble-clef
4. HOW TO READ SHEET MUSIC: CHANNEL YOUR INNER MUSICIAN WITH THESE SIMPLE STEPS! (Reading this article is highly recommended—The Inventor)
https://www.musicnotes.com/blog/2014/04/11/how-to-read-sheet-music/

Singers use Solfeggi system: Do, Re, Mi, Fa, Sol, La, Si (or Ti), Do (Octave above Do), in a relative pitch system. For each different key, scale, “Do” is moved to the Different scale root notes. This makes singers develop sense of Relative pitches. I recommend, to adopt one universal Solfege system, where “DO” is associated with the C, which helps singers develop absolute pitch sense. Otherwise, singers will have difficulty in singing ATONAL music.

### Solfège

This system, is called, Solfege, Solfeggi, solfeggio. Altering many half tones, half tone above with # (Sharp), or half tone below, with b (Flat). If you modify many notes, Diatonic Scale changes to Chromatic Scale. Romantic period composers loved to use Chromatic scale. It is a forerunner of atonal music. To help singers, in Solfeggi, in scaling up, letter “i” is added, as in Do, Di, Re, Ri, Fa, Fi, etc. In singing down the scale, letters “a” or “e” is used instead of i. For example, Si (or Ti), Se, Mi, Me. This conventions of Solfeggi system is not popularly used. This nurtures Relative Pitch senses in singers. So much so, many Singers have difficulty in singing atonal music. They largely depend on their ears and piano, to sing atonal music, or memorize by listening to recordings. The Inventor, encourages to use Universal Solfeggi, to develop sense of absolute pitches, and discourages Relative version of Solfeggi, where “Do” is constantly shifted to other notes, depending on Scale or Key.

It is better not to encourage use Solfeggi system at all.

In singing, Use “Tat, tat, tat” in short staccato for diction articulation, or Ah, ah, ah, or La, la, la” to develop Legato singing.

### BRIEF SUMMARY OF THE INVENTION

The expansion of sonority is achieved through the use of hands, fingers, fists, palms, in Hand-brush techniques. Notation systems, for Hand-brush techniques, are provided, along the pitch ID is attached to each note. Notations for Finger-brush techniques are provided, on top of each note. In Sang Lee's Music Notation system, “SALEMN”, Notes are limited to graphic to depict rhythm, and Time, duration of the sound. Pitch ID and notation for Hand-brush are also provided, attached to each Rhythmical note. This eliminates many traditional notation devices. All sound should be employed freely, to paint sound, sonority. Pitch ID is a composite of: Octave No.+“Dot”+Note ID. This is the Core of Sang Lee's Music Notation System. Pitch ID is attached to the Note stem. This is the entire SALEMN system. Note ID is assigned to each piano key, Black or White. It is the name of the Piano key. Since each note has a numerical number of the Pitch ID, there is no need of the sound component of Traditional Music Notations. Therefor, The Staff, 5 parallel lines, The Clef, G, F, C clefs, Key signatures, temporary symbols of #, b (flat), Rest Symbols (SALEMN simply does not assign Pitch ID to Rhythmical notes hence, no sound). Note ID, attached to Rhythmical Note ID, (i.e., Note number assigned 1 to 12, within an Octave, is the whole SALEMN system.

e.g., Note G, 8th key, within an Octave is consistent in all Octaves. Pitch ID is assigned to all Individual key, SALEMN has no need of Sound components of Traditional Music Notation.

### BRIEF DESCRIPTION OF DRAWINGS

Rhythmic Notes (Sang Lee's Notation Uses them Also)

FIG. 1

32nd Note

FIG. 2

16th

FIG. 3

Note 8th Note

Quarter Note

FIG. 5

Half Note

FIG. 6

Whole Note

FIG. 7

Dotted Note, Increase

Duration by ½ to 1.5 beat

FIG. 8

Digital Pitch ID, 2.7

(Octave ID, 2+Dot+Note ID, 7, “F #”, Can be attached to “Circle”, as 2.7)

FIG. 9

Placement of Chord

(C Triad, Octave 2, Pitch ID, 1=C, 5=E, 8=G)

FIG. 10

Rhythmic Note Format. May Flap, Circle up.

FIG. 11

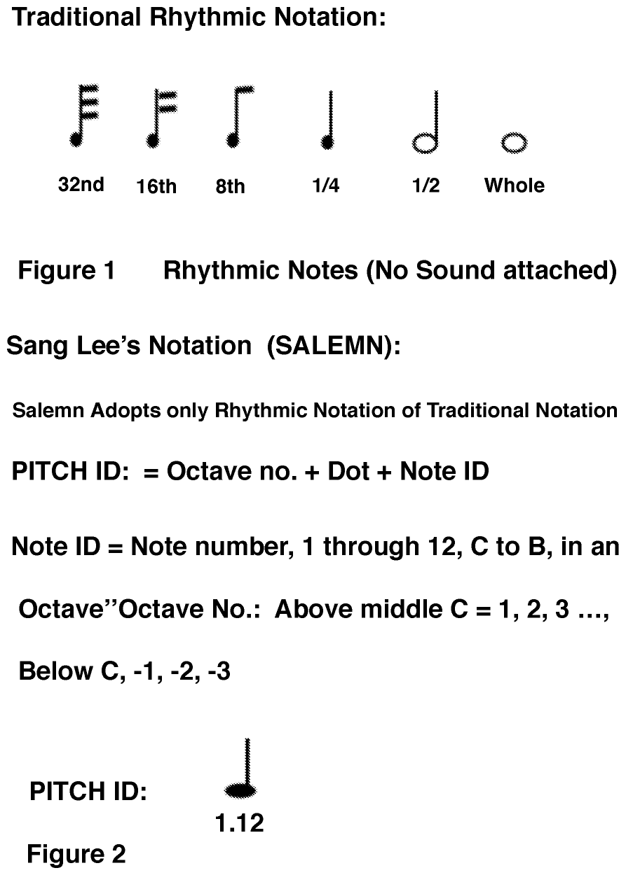

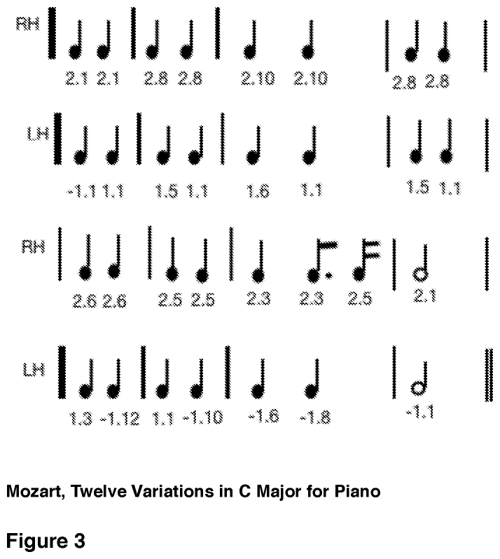

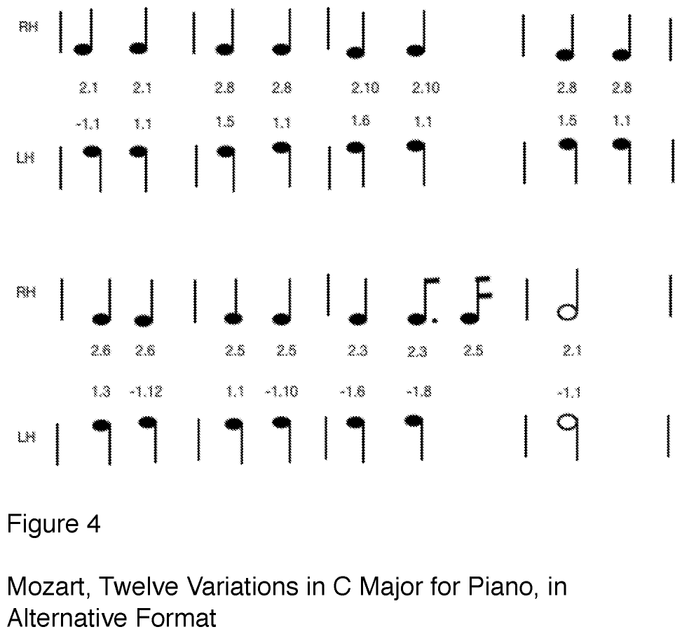

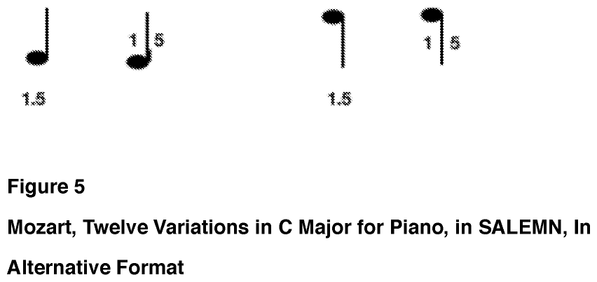

Piano Score Example

Mozart, Twelve Variations in C Major for Piano

### DETAILED DESCRIPTION OF THE INVENTION

### Sang Lee's Music Notation System, SALEMN

Traditional music notation system is continually embraced, but this Invention brings radical changes. Many of the traditional system features have been drastically changed or eliminated.

### A Brief Description of Changes are Listed Below:

Sang Lee's Music Notation System, is built upon assigning Note ID to 12 notes in equal half intervals, within each Octave. Each 12 key in an Octave is named from C to B, 1 through 12. Octaves above Middle C, are named 1, 2, 3, etc. Octaves Below Middle C, are named Negative number, −1, −2, −3, etc. Rhythmic note is provided with PITCH ID, Octave number and Note ID, in scores and descriptions. Octave no. and Note ID are separated by, a dot, or period, “.” for naming convention. This makes all notes have digital Pitch ID,_(Octave number+Dot+Note ID). The Dot or period, is aligned with the Stem of the notes. Octave no. on left of Stem, Note ID to Right, can eliminate Dot.

Hallowed Staff, 5 Parallel lines, are completely eliminated.

G, C, F, Clefs are removed, as a result of eliminating Staff. Sharp, and Flat symbols after the Clef for scale, are no longer needed. This leaves Rhythmic Note without sound. Assigning Pitch ID to Note, it gets pitch. Traditional graphical notes serve only for rhythms, Sound Duration. Traditionally, orchestra members are given part-scores only, to be shared with another player, making it difficult to turn pages. Sang Lee's Notation system, SALEMN, being digital, no longer needs any of the above. Not only it saves space for notation, Conductors and players have excellent Visual, Audio, command of other score parts. It affects, playing piano, Duets, String quartets, Trios, including Piano Trio, String ensemble, orchestras, and symphonies. Reading scores, and playing, are readily in sync, with other instrumentalists or vocalists. Shortening of Learning curve for Piano playing, will be astounding, for beginners, and children, as well as experienced pianists alike. Learning curves of all playing, will be drastically reduced. Eyes of players no longer busy to see notation of separate Clefs and Staff. All ensembles, and singing, soloists and chorus, would benefit. Notes are put on horizontal line for each instrumental part in Orchestral scores, such as Violin 1, Violin 2, Cello, etc. Ambiguity of notes, such as Enharmonic G #, Ab are gone. Notes are clearly pinned down for timing, and pitch. Dot between Octave number and Note ID, aligned with Stem would contribute to it. The new system may make many musicians, including singers, a chance to develop Absolute pitch senses. Each note sound, pitch, is remembered as a sound, not as a note elevated or lowered by a half interval from other relative notes. Generally, Pianists and instrumentalists, are not into relative pitches. In SALEMN, Vertical line, stem, of note, are aligned precisely with the attack point of ensemble for scores, namely Dot, period of note and Stems, aligning; (See Drawings)

### Hand-Brush Techniques and Notations:

Hand-Brush techniques restore Piano as Percussive instruments with new sound colors. Left and Right hands, LH, RH, can use different Hand-Brush techniques or engage in the same techniques or postures, for both Right and Left hands in unison, size of hands being different or imagination of players impacting. Performers are free to make decisions. Use own imagination and artistic sensitivity. This will provide many different coloring of musical sounds. Immediate impulse should govern. No players sound alike. Each player can bring in unique talents, innovation, creative impulse.

Conventionally, Finger 1, is called, Thumb, Finger 2, called Index Finger or Forefinger, Finger 3, Middle finger, the finger between the forefinger and the ring finger, Finger 4, Ring finger, Finger 5, Pinkie or Pinky. Finger 4 and Finger 5 have to be independent of each other. Finger 4 is much weaker than Finger 3. As Finger 3 moves up or down, Finger 4 tends to follow. Independent control of Finger 4, is very weak. Pianists try hard to make Finger 4 independent with little success. Pianists should be careful not to injure fingers. Hand-Brush is friendly to physiology of hands. Finger 5 is relatively free from Finger 4, but has little strength, unable to produce bigger sound than the rest of the brethren. Pianists struggle to make even, clear, articulated tones with all fingers. But, alas, mind willing, but finger 4 and finger 5 are physically not strong, to do that. Many pianist suffer from Carpal Tunnel Syndrome. Fingers lose control, and cannot play with the hand, suffering from this syndrome. Supposedly, the painful condition of hand and fingers, are caused by compression of a major nerve, that passes over the carpal bones through passage at the front of the wrist, alongside the flexor tendons, of the hand.

Also, repetitive, same motions, will contribute to this symptom. Famous pianist, Leon Fleisher and Gary Graffman, a former president of Curtis Institute of Music, and famous pianist, suffered from this ailment. Schumann's Piano teacher, and father of Schumann's wife Clara Wick, had high opinion of Schumann's career as pianist, before Schumann injured his finger. Wick felt, Schumann could become a concert pianist save finger injury. Schumann forced finger exercises, damaged fingers and gave up pianist career. This invention, changes that to radically different direction. Hand-Brushing, Physiologically friendly to Hand and fingers, would not harm fingers. The technique uses natural physiological functions of Hands. Strong percussive sound, even loudness of overtone, are enhanced. All hallowed Classical music is based on the principle of “One note per Finger” It burdens fingers heavily. Not all fingers share strength and agility equally. Depending on the size of hands and fingers, coverage of piano keys is different. It is stressed that composers may suggest fingers on notes, scores, but, effect is not the same depending on the size of hands, fingers, also artistic sensibility. The final decisions must be left up to individual players. Players can edit Hand-Brush techniques, anyway they like. Performance is collaboration of two minds, composer and player. Partly because of Hand sizes, but mainly, to respect the Performer's artistic sensitivity and imagination, performers should have final say, how, and what kind of sound, and colors, the performer wants.

In order to expand colors of sound, “Hand-Brush” techniques are recommended, and notation system for Hand-Brush, is provided in this patent application. Hand-Brush techniques, provide rich tonal palette of sound, without injuring fingers. A talented player, could paint own unique sonority.

To stress again, the Inventor believes strongly, performance is a cooperative venturer of Composers and Performers, particularly in coloring. Hand-Brush notations, are provided by Composers. But, performers are free to create, interpret, and change Hand-Brush notations. Super Big hands, fingers, fists, of people, require performer's adjustments. The Inventor believes strongly, Hand-Brushing alone, could produce splendid music, by an inspiring player. In Coloration for sonority, Composers may suggest, but Performers retain the right to make final decisions. The size of hands and fingers, fists, and minds driving, effect is different. One size does not fit all. This will encourage, to create flourishing colors by Billions of performers and composers. It will be astonishing, young children, and laymen, could shine brightly. Hand-Brush techniques are easily adopted by all, including children, and laymen as well. It makes possible for virtually anybody, to write and perform Piano music as in ancient times, using Hand-Brush techniques. It requires little training, only inspired minds.

How thrilling! How Refreshing! Classic music is finally liberated, to be embraced by all humanity, billions of minds and hearts.

Music is expanded from “Tonality only” to include all-inclusive musical world of tonality and atonality. No special formulas, are necessary. Music is freed from all theories, constrains. Only vision, creativity, and musical impulses are needed. Tonal landscape is free of all constrains.

Multi-tones used in Hand-brush music, would result in rich orchestration, since many instruments play rich array of different notes.

### Palette of Hand-Brush: Fists, Fingers, Palms:

Below, they apply all to RH, Right hand, and LH, Left hand. When a particular finger is preferred, that finger number is aligned with top of the note stem. A performer may change or edit them.

Performers are free to introduce their own additional Hand-Brush techniques. Ultimately, the effect of the tone clusters of Hand-Brush techniques, is up to performers.

“F” stands for Fist, “f” (lower case) stands for fingers, “P” stands for Palm, and “p” for Pizziccato, “G” stands for Glissando.

Fist is made by gently squeezing fingers, with four fingers bent gently at the first digits, joint, knuckles, forming flat surface. Thumb is gently stretched, with its tip meeting the end of the first bent knuckle of the Index finger. Description below applies to both hands, RH, and LH.

### Fists: F1, F2, F3, F4.

Fist is made with curling four fingers gently, in squeezing shape, 4 Finger tips touching along the middle of the palm.

### F1 Position:

Bottom of the Pinkies.

F1-2

Bottom of the Pinkies and Narrow Part of palm next to Bottom of the Pinkie.

### F2 Position:

Flat, Small palm area next to Pinkie.

### F3 Position:

Use four, first finger digits, as if stamping down.

### F4 Position:

Use Second finger digits, Fists facing down.

f1-4 finger tips: “f” (lower case) with finger numbers; f1, f2, f2-3,

f2, 3, 4, f4, numbers standing for finger number) are used, f1, being Thumb,

f2 being index finger. f3 being Middle finger, and f4 being Ring finger, f5 Pinkie.

Palms: P stands for palms gently stretched across the keyboard. Use bottom of fingers contacting keys, with nail side up.

P1, one finger stretched, or Side of Thumb.

P2-3, Index and middle fingers stretched.

P2-4, Fingers 2, 3, 4, or any one or more fingers in combination.

P2-5, Fingers 2, 3, 4, 5, or any one or more fingers in combination.

G: Glissando, G, followed by number of fingers to be used.

In Glissando, going upwards, top of the fingers are used. Going downwards, bottom of fingers are used.

“p”, Lower case, designates Pizzicato, with finger numbers.

G1 Thumb.

G2. Index finger (finger 2, Nail side down)

G2-3 Index finger and Middle finger (finger 2-3).

G2-4 Index finger, Middle finger, and Ring finger (finger 2, 3, 4)

G3-5 Middle finger, Ring Finger, and Pinky finger. (fingers 3, 4, 5)

S for Swiping, (Short Glissando) or Gentle Brushing.

STC—Staccato, accentuate, gently, or sharply.

### Future Impact of SALEMN in the Digital Age:

Unlike the Traditional Music Notation System, where individual note has no discernible, identifiable tag, SALEMN, has Bar number, and Note ID, PITCH ID numbers. Therefore, it is possible to input Note Data, in a computer database. Salemn can store in a computer database system, Bar number, Identical Note Occurrence number (since there may be more than one identical note present within a Bar).

This is a very significant attribute, opening up a whole new aspects in musicology, Research in music theory, composers, conductors, players, to analyze a work in their respective interests and research. Furthermore, a central organizational database, musical works and recording, can be stored, and musicians, and interested persons can research and gather data. Motives, Themes, any Sound configuration, can be searched for examination. The whole theme, part configuration of theme, can be searched as well. This will provide, systematic, analytical, structural research, to have deeper understanding of the musical work. Orchestral members, may use a thin Tablet computer, downloading necessary works from the central database. In the concert, tablet would be put on a stand, read in performance. The screen can be touch-sensitive with tags, to change display as performance proceeds. Conductors can instantly rehearse a desired part with orchestra. Current music notation system cannot do any of these. It will be much more convenient to use, than hard paper copies. All works, do not have to be published in hard copy, and carry around for concerts. It will be much more logistical for concert tours. Music instructions and discussions in a teaching setting, would benefit tremendously. I look forward eagerly the day where, millions of minds, display dazzling musical works, on YouTube. It reminds me of, Higgs field, where particles get mass. In SALEMN, Pitch ID gives sound to Rhythmic Note, on a flat horizontal line. Conductors never get lost.

1. The Object of the Invention: Sang Lee's Music Notation System, comprising: Pitch ID, with two components, Octave number,
and Note ID within an Octave, and Rhythmical Notation, eliminates all Sound components of Traditional Notation System.

2. The invention of Hand-Brushing Notation System, Comprising: the use of Fists, Fingers, Palms, to provide a rich palette of colors of tone clusters, are physiologically compatible with hand structures, enabling all people, to write, and play, New Music.
